(19) United States
(12) Patent Application Publication
(10) Pub. No.: US 2025/0222571 A1
(43) Pub. Date: Jul. 10, 2025

(54) AUTOFEED SCREWDRIVER ATTACHMENT WITH FASTENER ADVANCE STOPPER

(71) Applicant: Kyocera Senco Industrial Tools, Inc., Cincinnati, OH (US)

(72) Inventors: Gregory M. Gottlieb, Loveland, OH (US); Taiki Tsuru, Mason, OH (US); Braedon S. Flamm, Liberty Township, OH (US)

(73) Assignee: Kyocera Senco Industrial Tools, Inc., Cincinnati, OH (US)

(21) Appl. No.: 19/001,681

(22) Filed: Dec. 26, 2024

Related U.S. Application Data
(60) Provisional application No. 63/618,698, filed on Jan. 8, 2024.

(51) Int. Cl. B25B 23/04; B25B 21/00

(52) U.S. Cl. CPC B25B 23/045; B25B 21/00

(57) ABSTRACT

A stopper for an autofeed screwdriver attachment designed for mounting to a manual-feed screw gun that prevents overshooting when advancing a collated strip of fasteners during operation. The attachment has a nosepiece that protrudes from the front end, and this nosepiece is also used as a guide to drive fasteners into a workpiece. The nosepiece is depressed as the fastener is driven, and automatically extends when released from the workpiece. As the nosepiece extends, it rotates a pair of sprockets, which advances the collated fastener strip. This sequence is referred to as an “index on return.” The stopper contacts one of the sprockets to prevent it from further rotation, thus preventing any overshooting of the collated fastener strip. When the nosepiece is depressed again, the stopper releases contact with one of the sprockets.

### CROSS-REFERENCE TO RELATED APPLICATIONS

The present application claims priority to provisional patent application Ser. No. 63/618,698, titled “AUTOFEED SCREWDRIVER ATTACHMENT WITH FASTENER ADVANCE STOPPER,” filed on Jan. 8, 2024.

### TECHNICAL FIELD

The technology disclosed herein relates generally to automatic screwdriving equipment and is particularly directed to an autofeed attachment of a type that can be mounted to a manual-feed screw gun, thereby converting the tool into an automatic feed screw gun. Embodiments are specifically disclosed as having a nosepiece in mechanical communication with at least one fastener advance sprocket, and a stopper that contacts the sprocket to prevent overshooting while a collated fastener strip is being advanced. When the attachment is in operation, the nosepiece is depressed in order to drive a fastener into a workpiece. The nosepiece is then released from the workpiece and automatically extends, forcing the at least one fastener advance sprocket to rotate which advances the collated fastener strip for the next drive. This sequence is sometimes referred to herein as “index on return.” The stopper moves into contact with the at least one fastener advance sprocket to prevent the sprocket from further rotation, thereby preventing any overshooting of the collated fastener strip. When the nosepiece is depressed again, the stopper moves out of contact with the at least one fastener advance sprocket.

The attachment includes a manually-actuated release bar subassembly, which allows a user to feed or remove the collated strip of fasteners. The release bar subassembly is typically in a “disengaged” position, in which the attachment is permitted to operate normally. However, the release bar subassembly can be manually adjusted into an “engaged” position, in which a user is able to remove a collated fastener strip from the attachment, or to feed a collated fastener strip onto the attachment. In this engaged position, the release bar forces the nosepiece out of mechanical communication with the at least one fastener advance sprocket and moves the stopper out of contact with the at least one fastener advance sprocket, so that the at least one fastener advance sprocket can “freewheel” in one direction to either load or remove a collated fastener strip.

### STATEMENT REGARDING FEDERALLY SPONSORED RESEARCH OR DEVELOPMENT

None.

### BACKGROUND

Several manufacturers of power tools sell manually-fed (“single-feed”) screwdriving tools, and some of those manufacturers also sell automatic-feed (or “autofeed”) screwdriving tools. The autofeed screwdriving tools typically use some type of collated strips that hold multiple screws at fairly precise intervals, and these collated strips of screws are fed into an indexing mechanism at the front portion of the autofeed screwdriving tool. The user has to merely place the front tip of the tool against a workpiece, and then pull the trigger on the tool while pressing the tool against the workpiece. When that occurs, the tool will automatically index a screw to the “driving position,” and a drive bit will begin turning and will be pushed into the head of the screw, and then drive the screw all the way into the workpiece. This sequence is sometimes referred to herein as “index on advance.” This type of tool is well-known, and often used by professional carpenters and other construction workers.

Some automatic-feed screwdriving tools operate in a mode that is the opposite of index on advance. As noted above, such autofeed tools are typically referred to as “index on return” tools, since they will automatically index the ‘next’ screw to the “lead” position (or “driving position”) as the slide body (with the sprocket) is extending during a return stroke of the tool, i.e., just after the tool has completed a drive (or driving) stroke. In that manner, there will be a “lead” screw physically located at the “driving position” before the human user of the tool begins a driving stroke, and therefore, that user will be able to visually see exactly where that “lead” screw will be placed into the target workpiece (typically a wood or metal substrate) before the user initiates the driving stroke.

The manually-fed screwdriving tools are used in many other situations, including people who are not necessarily professional construction workers, but nevertheless want to have a power tool for driving screws. Even professional carpenters and other construction workers will sometimes use a non-autofeed screwdriving tool, for certain purposes. This is especially popular in situations where a person already has a manually-fed screwdriving tool, but also purchases an autofeed attachment that can be affixed to the front end of the manually-fed screwdriving tool, thereby converting it into an automatic screwdriving gun. Such attachments also are well-known and popular in many construction situations. In this configuration, the attachment becomes the “front-end tool portion” of the overall tool, and the manually-fed screwdriving tool becomes the “back-end tool portion” (or the “back-end tool”) of the overall tool.

At times, automatic-feed screwdriving tools that index on return have a tendency to overshoot the sprocket position during the indexing. If that occurs, then the drive bit may not be able to properly engage with the “lead” screw (i.e., the “next” screw that is to be driven in the next driving stroke of the tool), and therefore, the next driving stroke will be unsuccessful in driving one of the screws from the collated strip of screws that is installed on the sprocket.

### SUMMARY

Accordingly, it is an advantage to provide an autofeed attachment that converts a manual-feed screw gun into an automatic feed screw gun, in which the attachment includes an “index on return” system for advancing a collated fastener strip.

It is another advantage to provide an autofeed attachment that uses a stopper to contact at least one fastener strip advance sprocket so that, during a final phase of a return stroke (after driving a fastener), the sprocket is prevented from further rotation, thus preventing any overshooting of a collated fastener strip that has been loaded into the attachment.

It is yet another advantage to provide a release bar subassembly for an autofeed attachment that, when a release bar subassembly is moved to an engaged position, it forces a nosepiece linkage out of mechanical communication with the fastener strip advance sprocket, and also forces the stopper out of mechanical communication with the fastener strip advance sprocket, thereby allowing the sprocket to “freewheel” in one direction so that a user can easily remove or load a collated fastener strip.

It is still another advantage to provide an autofeed attachment having a stopper that prevents a collated fastener strip from overshooting during a final phase of a return stroke as a nosepiece has been removed from a substrate, and during an initial phase of the next drive stroke the stopper releases when the nosepiece is pushed against a target substrate for driving the next fastener.

Additional advantages and other novel features will be set forth in part in the description that follows and in part will become apparent to those skilled in the art upon examination of the following or may be learned with the practice of the technology disclosed herein.

To achieve the foregoing and other advantages, and in accordance with one aspect, a slide body subassembly for an automatic fastener driving tool is provided, which slide body subassembly comprises: (a) a drive gear having a first axis of rotation, said drive gear having a first set of engagement projections along one of its surfaces at a first position along said first axis of rotation; (b) a sprocket having a second axis of rotation that is substantially parallel to said first axis of rotation, and that is spaced-apart from said drive gear, said sprocket having a first plurality of spaced-apart protrusions along an outer curved surface at a third position along said second axis of rotation, said sprocket having a second set of engagement projections at a fourth position along said second axis of rotation; (c) a drive belt that runs between said drive gear and said sprocket, said drive belt having a plurality of spaced-apart bulges along one of its surfaces, said plurality of spaced-apart bulges being in mechanical engagement with said first set of engagement projections of said drive gear and being in mechanical engagement with said second set of engagement projections of said sprocket, said drive belt being caused to move if said drive gear rotates, and said drive belt then causing said sprocket to rotate; (d) a flexible collated strip of fasteners that slides over a surface of said slide body subassembly, said flexible strip having a plurality of spaced-apart openings that engage with said first plurality of spaced-apart protrusions of the sprocket, and are thereby indexed into a drive position by rotation action of said sprocket about said second axis of rotation; (e) a feed pawl subassembly that is associated with the drive gear, said feed pawl subassembly including an extending finger; and (f) a stopper that includes a plurality of protrusions, said stopper being positioned in a space between said drive gear and said sprocket, wherein: (i) if the stopper is moved to a first position, a final one of the stopper's plurality of protrusions makes contact with the sprocket and prevents the sprocket from overshooting; (ii) if the stopper is moved to a second position, none of the stopper's plurality of protrusions makes contact with the sprocket, and said sprocket is free to rotate and thereby allow said flexible collated strip of fasteners to be indexed as needed to place a fastener at an appropriate drive position; (iii) if in operation, during a drive stroke, the sprocket remains in place at least until a drive bit contacts a “lead” fastener to be driven; (iv) if in operation, before a first phase of a return stroke, the extending finger of said feed pawl subassembly makes physical contact with a first one of the plurality of protrusions of the stopper, which causes the stopper to move toward the second position, thereby allowing the sprocket to rotate; (v) if in operation, during a second phase of the return stroke, the sprocket is indexed to place a “next” fastener at a “lead” position, where it is ready to be driven by the drive bit; and (iv) if in operation, during a third phase of the return stroke, the extending finger of said feed pawl subassembly makes physical contact with a second one of the plurality of protrusions of the stopper, which causes the stopper to move to the first position, which thereby prevents the sprocket from overshooting.

In accordance with another aspect, an autofeed screwdriver attachment is provided, which comprises: a movable slide body including an independently movable nosepiece; a rotatable drive bit; a drive gear, a sprocket, and a drive belt that runs between the drive gear and the sprocket; a stopper exhibiting a plurality of protrusions, the stopper located between the drive gear and the sprocket; and a flexible collated strip of screws that engage with the sprocket; wherein: the nosepiece is movable between an extended position, and a retracted position, the nosepiece being in mechanical communication with the drive gear; at an initial portion of a driving stroke, the nosepiece resides in the extended position, and the rotatable drive bit is not yet contacting one of the screws of the flexible collated strip of screws; at the end of the driving stroke, the nosepiece resides in the retracted position, and none of the plurality of protrusions makes contact with the sprocket; and during a return stoke, the nosepiece automatically returns to the extended position from the retracted position, and a final one of the plurality of protrusions is moved into contact with the sprocket.

In accordance with yet another aspect, a method for advancing a fastener for an attachment to a power tool is provided, in which the method comprises: (a) providing a power tool attachment including: a movable slide body including a movable nosepiece; a rotatable drive bit; a drive gear, a sprocket, and a drive belt that runs between the drive gear and the sprocket, the drive gear being in mechanical communication with the movable nosepiece; and a stopper exhibiting a plurality of protrusions, the stopper located between the drive gear and the sprocket; (b) providing a flexible collated strip of fasteners that engage with the sprocket; (c) before beginning a driving stroke, the stopper is in a first position, in which a final one of the plurality of protrusions of the stopper is in contact with the sprocket, thereby preventing overshooting of the sprocket; (d) beginning an operating cycle with a driving stroke by depressing the movable nosepiece against a substrate, causing the movable nosepiece to move toward a retracted position; wherein: the rotatable drive bit contacts one of the fasteners of the flexible strip of fasteners; and the stopper moves to a second position, causing the final one of the plurality of protrusions to move out of contact with the sprocket, thereby allowing the sprocket to rotate; and (e) completing the operating cycle with a return stroke by removing the movable nosepiece from the substrate; wherein: the movable nosepiece automatically moves to an extended position; the rotatable drive bit moves out of contact with one of the fasteners of the flexible strip of fasteners; and the stopper moves back to the first position, and the final one of the plurality of protrusions moves into contact with the sprocket, thereby preventing overshooting.

In accordance with still another aspect, a method for loading a flexible strip of fasteners for an attachment to a power tool is provided, in which the method comprises: (a) providing a power tool attachment including: (a) providing a power tool attachment including: a movable slide body including a movable nosepiece; a rotatable drive bit; a drive gear, a sprocket, and a drive belt that runs between the drive gear and the sprocket, the drive gear being in mechanical communication with the movable nosepiece; a stopper exhibiting a plurality of protrusions, the stopper being located between the drive gear and the sprocket; and a release bar subassembly that is movable between a disengaged position and an engaged position; (b) providing a flexible strip of collated fasteners that are engageable with the sprocket; (c) the release bar subassembly is at a disengaged position as a default mode of operation, wherein: the nosepiece is in mechanical communication with the drive gear; the stopper moves to a first position in which a final one of the plurality of protrusions is in contact with the sprocket; and the stopper prevents the sprocket from indexing in at least one direction; (d) moving the release bar subassembly to the engaged position, wherein: the nosepiece is not in mechanical communication with the drive gear; the stopper moves to a second position and is not in contact with the sprocket; and the sprocket can freewheel in at least one direction; and (e) loading the flexible strip of fasteners onto the sprocket.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is a perspective view of an autofeed attachment for a screw gun, as constructed according to the principles of the technology disclosed herein.

FIG. 2 is a left-side view of the attachment of FIG. 1 with part of the slide body not depicted, showing some of the major components of the technology.

FIG. 3 is a perspective view of the attachment of FIG. 1 with the housing not depicted, showing some of the major components of the technology.

FIG. 4 is a partial exploded view of the attachment of FIG. 1.

FIG. 5 is a right-side elevational view of the attachment of FIG. 1.

FIG. 6 is a right-side view of the attachment of FIG. 1 with part of the slide body not depicted, showing the attachment during an “active” driving state, after the nosepiece and slide body have been almost fully pushed in while driving a fastener.

FIG. 7 is a right-side view of the attachment of FIG. 1 with part of the slide body not depicted, with the alternative embodiment release bar, showing the attachment in the “neutral” state, where it is ready to unload a partially-used strip of fasteners, or to load a fresh strip of fasteners.

FIG. 8 is a right-side view of the attachment of FIG. 1 with part of the slide body not depicted, with the alternative embodiment release bar, showing the attachment in a “locked” state in which the fastener strip cannot overshoot, which is also the default state of the stopper between driving actuations (or “drive strokes”) of the screw-driving tool.

FIG. 9 is a perspective view of the attachment of FIG. 1 with part of the slide body not depicted, showing the attachment in the “locked” state.

FIG. 10 is a perspective view of the housing of the release bar, of the attachment of FIG. 1.

FIG. 11 is a perspective view of the release bar, of the attachment of FIG. 1.

FIG. 12 is a front elevational perspective view of the release bar and release bar housing, of the attachment of FIG. 1.

FIG. 13 is a perspective view of the release bar and release bar housing in a default “disengaged” state, of the attachment of FIG. 1.

FIG. 14 is a perspective view of the release bar and release bar housing in an “engaged” state, of the attachment of FIG. 1.

FIG. 15 is a front elevational view of the release bar and release bar housing showing a disengaged state of the release bar, of the attachment of FIG. 1.

FIG. 16 is a perspective view of the release bar and release bar housing showing an engaged state of the release bar, of the attachment of FIG. 1.

FIG. 17 is a left front perspective view of a second alternative embodiment release bar, showing a portion of the attachment of FIG. 1 in see-through.

FIG. 18 is a left rear perspective view of the second alternative embodiment release bar, showing a disengaged state of the attachment of FIG. 1.

FIG. 19 is a right rear perspective view of the second alternative embodiment release bar, of the attachment of FIG. 1.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” or “mounted,” and variations thereof herein are used broadly and encompass direct and indirect connections, couplings, or mountings. In addition, the terms “connected” or “coupled” and variations thereof are not restricted to physical or mechanical connections or couplings. Furthermore, the terms “communicating with” or “in communications with” refer to two different physical or virtual elements that somehow pass signals or information between each other, whether that transfer of signals or information is direct or whether there are additional physical or virtual elements therebetween that are also involved in that passing of signals or information. Moreover, the term “in communication with” can also refer to a mechanical, hydraulic, or pneumatic system in which one end (a “first end”) of the “communication” may be the “cause” of a certain impetus to occur (such as a mechanical movement, or a hydraulic or pneumatic change of state) and the other end (a “second end”) of the “communication” may receive the “effect” of that movement/change of state, whether there are intermediate components between the “first end” and the “second end,” or not. If a product has moving parts that rely on magnetic fields, or somehow detects a change in a magnetic field, or if data is passed from one electronic device to another by use of a magnetic field, then one could refer to those situations as items that are “in magnetic communication with” each other, in which one end of the “communication” may induce a magnetic field, and the other end may receive that magnetic field, and be acted on (or otherwise affected) by that magnetic field.

The terms “first” or “second” preceding an element name, e.g., first inlet, second inlet, etc., are used for identification purposes to distinguish between similar or related elements, results or concepts, and are not intended to necessarily imply order, nor are the terms “first” or “second” intended to preclude the inclusion of additional similar or related elements, results or concepts, unless otherwise indicated.

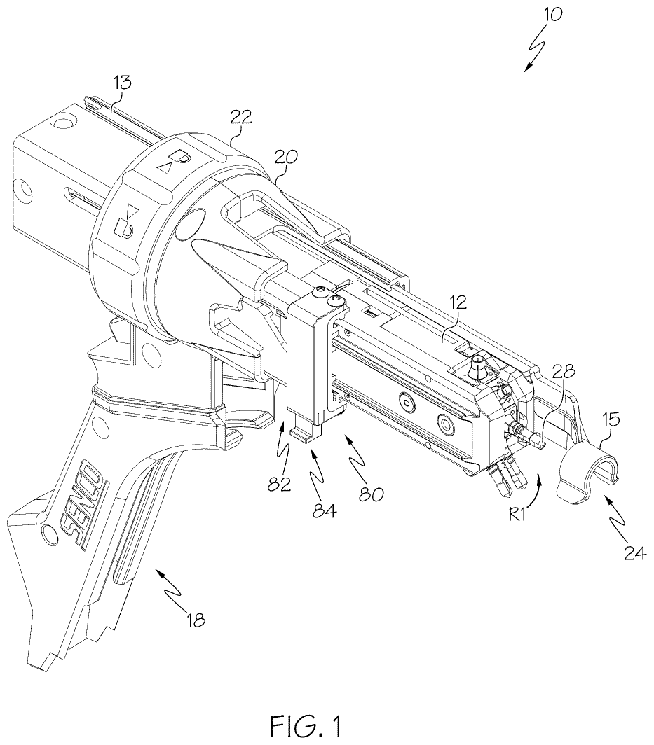

Referring now to FIG. 1, a hand-held autofeed fastener driving tool attachment is depicted, generally designated by the reference numeral 10. Sometimes such an attachment assembly 10 is referred to merely as the “attachment,” or sometimes referred to as the “tool” or the “attachment tool.”

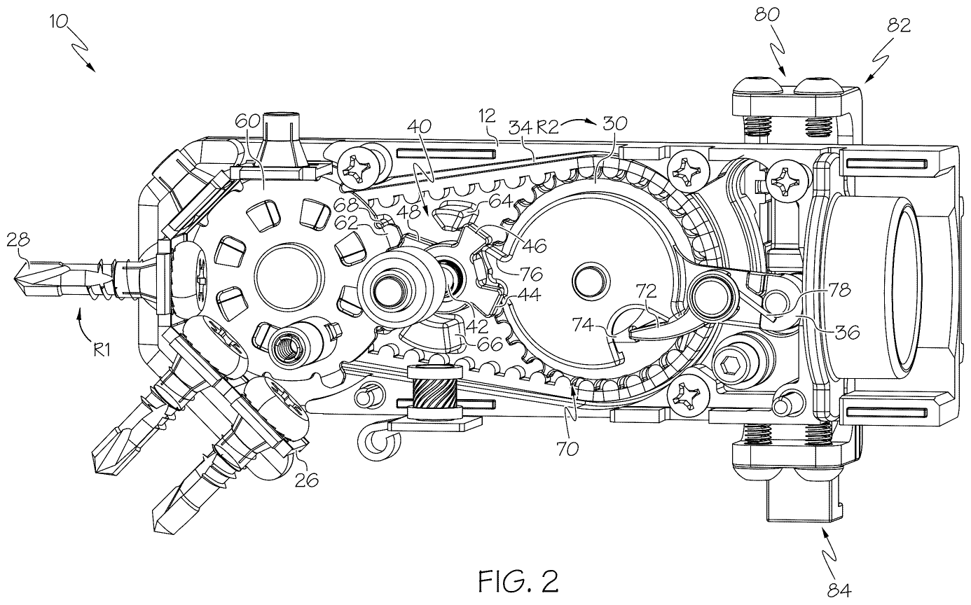

The attachment 10 includes an outer housing portion 20, and a locking collar 22. The locking collar 22 rotates to secure the attachment 10 to a manual-feed screw gun, and the combination of the attachment 10 and the manual-feed screw gun is an autofeed screw gun. A collated strip of fasteners 26 (partially depicted on FIG. 2) is fed through a guide portion 18 and through an exit end 24, in a direction R1. Each one of a plurality of fasteners 28 is sequentially advanced through the exit end 24 during operation of the tool 10.

The attachment 10 includes a moveable nosepiece 15 which is attached to a slide body 12. Both the nosepiece 15 and the slide body 12 are moveable in a longitudinal direction of the attachment 10, and when the nosepiece 12 is pressed against a solid object, the attachment 10 will be actuated to physically drive one of the fasteners 28 into a solid object. A user then pushes both the nosepiece 15 and the slide body 12 fully onto the substrate to drive a fastener (i.e., both the slide body 12 and the nosepiece 15 are fully retracted at the end of a drive stroke). Both the nosepiece 15 and the slide body 12 will “collapse” into a feed tube 13 when the tool 10 is pressed against a substrate. As the user lifts the tool 10 from the substrate, the nosepiece 15 and the slide body 12 automatically extend fully from the feed tube 13.

Some of the mechanical mechanisms described above for the portable fastener driving tool 10 have been available in the past from Senco Products, Inc. and Senco Brands, Inc., including such tools as the Senco Model Nos. DS162-14V and DS200-14V. Some of the components used in the technology disclosed herein have been disclosed in commonly-assigned patents or patent applications, including a U.S. Pat. No. 5,988,026, titled SCREW FEED AND DRIVER FOR A SCREW DRIVING TOOL; a U.S. Pat. No. 7,032,482, titled TENSIONING DEVICE APPARATUS FOR A BOTTOM FEED SCREW DRIVING TOOL FOR USE WITH COLLATED SCREWS; a U.S. Pat. No. 7,082,857, titled SLIDING RAIL CONTAINMENT DEVICE FOR FLEXIBLE COLLATED SCREWS USED WITH A TOP FEED SCREW DRIVING TOOL; a U.S. Pat. No. 8,869,656, titled SCREWDRIVER TOOL WITH IMPROVED CORNER FIT FUNCTION; a U.S. Pat. No. 8,627,749, titled SCREWDRIVER TOOL WITH IMPROVED CORNER FIT FUNCTION; and a U.S. Pat. No. 8,726,765, titled SCREWDRIVER TOOL WITH IMPROVED LINEAR TRACKING. These patent properties have been assigned to Senco Brands, Inc., or to Kyocera Senco Industrial Tools, Inc., and their disclosures are incorporated herein by reference in their entireties.

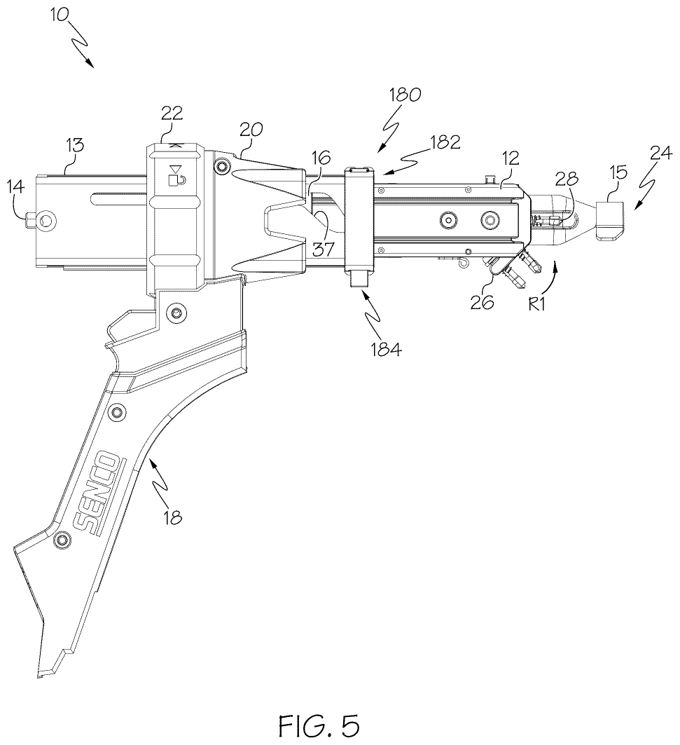

A release bar sub-assembly 80 (“S/A”) is mounted to an outside portion of the slide body 12. The release bar S/A 80 includes a stationary housing 82 and a movable pusher 84. When the pusher 84 is “down,” as depicted in FIG. 1, the release bar S/A 80 is in a “disengaged” state in which the pusher 84 is not in mechanical communication with a rear portion of the nosepiece 16 (see FIG. 5). The disengaged state is the default state of the release bar S/A 80, and the tool 10 can be operated normally when the pusher 84 is disengaged.

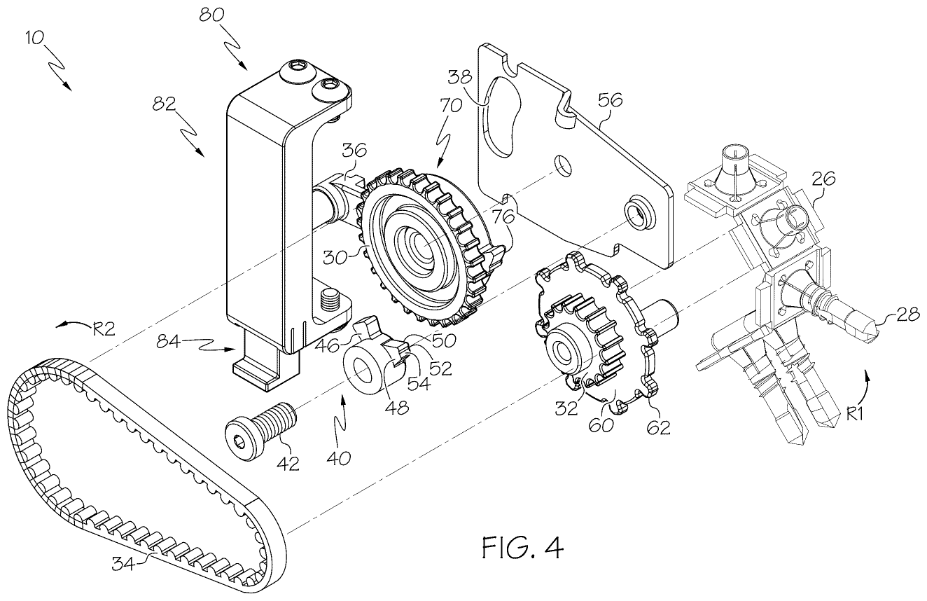

When a user wishes to unload the collated strip 26, or to load a new collated strip, then the pusher 84 is manually pushed “up” by the user into an “engaged” state (see FIG. 14). A contact portion 99 (see FIG. 11) contacts and forces “up” a cam roller 36 (see FIG. 4). The cam roller 36 is able to move “up” and “down” within the stationary housing 82, and in the “up” position, the nosepiece 15 is mechanically disconnected from the fastener advance system, thereby allowing a user to load or unload a collated strip of fasteners 28. The fastener advance system will be discussed in more detail below.

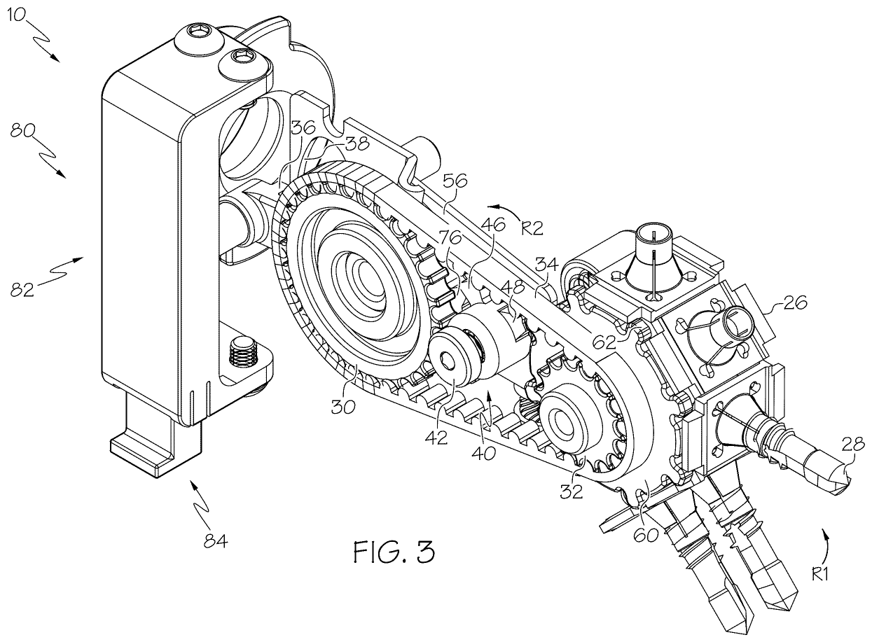

Referring now to FIG. 2, some of the components of the feed mechanism are depicted. A drive gear 30, having a first axis of rotation, and including a first set of engagement projections (also sometimes referred to herein as a “plurality of teeth”) at a first position along the first axis of rotation. A sprocket 60, having a second axis of rotation that is substantially parallel to the first axis of rotation and is spaced-apart from the drive gear 30, and including a first plurality of spaced-apart extensions 62 (also sometimes referred to herein as a first plurality of spaced-apart protrusions) along an outer curved surface at a third position along the second axis of rotation, and also including a driven gear 32 having a second set of engagement projections (see FIG. 3) at a fourth position along the second axis of rotation. A drive belt 34 that runs between the drive gear 30 and the sprocket 60, and the belt 34 having a plurality of spaced-apart bulges along one of its surfaces. The plurality of spaced-apart bulges is in mechanical engagement with the first set of engagement projections and with the second set of engagement projections, in which the belt 34 is moved if the drive gear 30 rotates, and the belt 34 then causes the sprocket 60 and the driven gear 32 to rotate.

The collated screw strip 26 directly contacts the sprocket 60 and the plurality of extensions 62, and the collated screw strip 26 slides over a surface of the slide body 12. The belt 34 rotates in a direction R2, and cannot rotate in a reverse direction due to a one-way clutch 72. The clutch 72 contacts one of a plurality of feed pawl protrusions 74 to prevent reverse rotation of the drive gear 30, and a spring 78 biases the clutch 72 towards each feed pawl protrusion 74. Both the clutch 72 and the feed pawl protrusion 74 are part of a feed pawl sub-assembly (“S/A”) 70.

The feed pawl S/A 70 also includes a finger 76 that contacts a stopper 40. The stopper 40 includes three protrusions: “A” at reference numeral 44, “B” at reference numeral 46, and “C” at reference numeral 48, as well as a hub 42 that allows the stopper to rotate back and forth during operation of the tool 10. FIG. 2 depicts the finger 76 in contact with the protrusion B (at 46), which indicates that the tool 10 is in a locked position, in which the sprocket 60 cannot overshoot and move the screw 28 out of alignment with a drive bit 14 (see FIG. 5) for the next drive stroke.

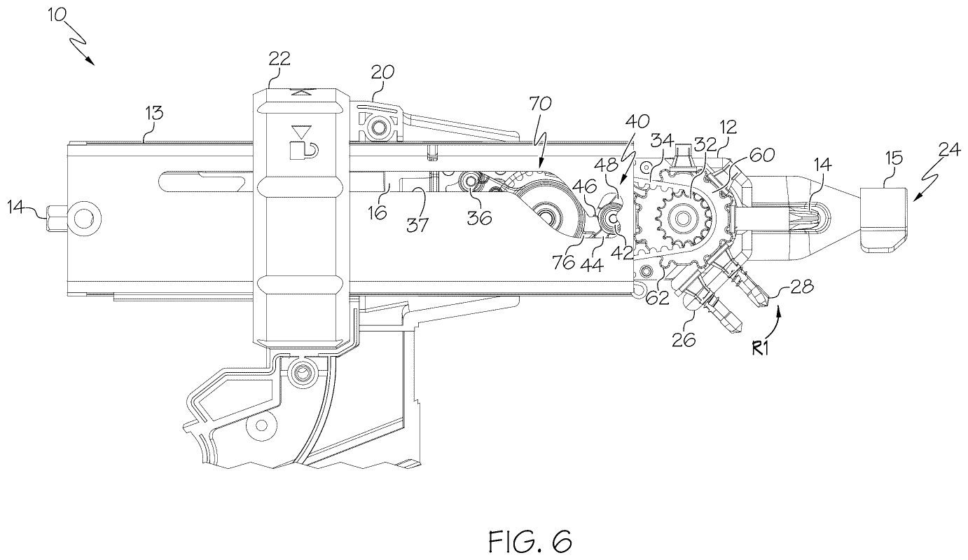

The stopper 40 is also constrained by three protrusions on an inside surface of the slide body 12: a first hard stop 64, a second hard stop 66, and a curved stopper guide 68. The first hard stop 64 prevents the stopper 40 from over-rotating during the locked state, the second hard stop 66 prevents the stopper 40 from over-rotating during an active (driving) state (see FIG. 6), and the guide 68 generally constrains the stopper 40. The protrusion B (at 46) contacts the first hard stop 64 in the locked state, the protrusion A contacts the second hard stop 66 in the active state, and the protrusion C (at 48) contacts the stopper guide 68 during operation of the tool 10.

In FIG. 2, the pusher 84 is in the disengaged position with the cam roller 36. In other words, FIG. 2 depicts the tool 10 ready to drive a screw 28 into a workpiece, and the collated screw strip 26 cannot be unloaded in this operating state.

Referring now to FIG. 3, the sprocket 60 includes a small driven gear 32 on one side. This driven gear 32 and the gear 30 mesh with the belt 34. The collated screw strip 26 meshes with the plurality of extensions 62. A plate 56 is illustrated in FIG. 3, and it is positioned to cover some of the mechanical components shown in FIG. 2. FIG. 3 also depicts a clutch guide 38, and the clutch 72 is constrained by that clutch guide 38. Note that the nosepiece 15 includes the rear portion 16 (see FIG. 6) that is in mechanical communication with the cam roller 36.

Referring now to FIG. 4, the protrusion C (at 48) includes a curved portion 50, an indent portion 52 (also sometimes referred to herein as a “detent portion,” a “seat,” or a “notch”), and a flat portion 54. After a screw 28 is driven into a workpiece, the feed mechanism begins to advance the next screw as the nosepiece 15 is lifted off of the workpiece. This is sometimes referred to herein as an “index on return” system. As the nosepiece 15 is lifted away from the workpiece (i.e., a “return stroke”), it is automatically returned to its extended position (as depicted in FIG. 1, for example).

This nosepiece 15 movement also moves the cam roller 36 “forward and down” within a cam profile slot 37 (see FIG. 5), thereby actuating the feed pawl S/A 70 and the gear 30. The one-way clutch 72 slides over one of the protrusions 74 as the gear 30 forces the belt 34 to rotate, while simultaneously forcing the driven gear 32 and the sprocket 60 to rotate. The finger 76 begins to move and contact the protrusion B (at 46) of the stopper 40. The rotation of the stopper 40 also rotates the protrusion C (at 48). As the sprocket 60 rotates and moves the collated screw strip 26 “up” one screw, the protrusion C (at 48) contacts and “catches” one of the sprocket extensions 62 at the notch 52. At this point the “index on return” operation is complete, and the locked position, as depicted in FIG. 8, has been reached.

In the locked position, the sprocket 60 cannot overshoot, due to the protrusion's 28 contact with the notch 52 on the protrusion C (at 48) of the stopper 40. A user can now accurately line up the next drive sequence, using the protruding screw 28 as a guide, and the bit 14 will correctly engage that protruding screw.

To return to the active state, the user presses the nosepiece 15 against a workpiece, which forces the cam roller 36 “up and towards the rear” within the cam profile slot 37 (see FIG. 6). This movement actuates the one-way clutch 72 out of contact with the protrusion 74, and moves the finger 76 “down” so that it moves out of contact with the protrusion B (at 46) and into contact with the protrusion A (at 44). The sprocket extension 62 slides out of the notch 52 and fully out of contact with the protrusions C (at 48), which releases the sprocket 60 to advance the next screw 28 when the drive is complete.

It should be noted that as the nosepiece 15 and slide body 12 are “pushed in” (e.g., retracted into the feed tube 13) the stopper 40 quickly moves out of contact with one of the sprocket extensions 62. This initial sequence is also sometimes referred to herein as a “first phase of the drive stroke.” Once the drive bit 14 contacts one of the plurality of screws 28, the user then continues pushing in the nosepiece 15 and slide body 12 to fully drive the screw into the substrate. This final sequence is also sometimes referred to herein as a “second phase of the drive stroke.”

Referring now to FIG. 5, the attachment 10 is depicted ready to drive a screw 28 into a workpiece. Note that the rear portion 16 of the nosepiece and the rear portion of the drive bit 14 are illustrated in this view. It should be noted that FIGS. 5-8 depict an alternative embodiment movable release bar sub-assembly (“S/A”) 180, an alternative housing 182, and an alternative pusher 184. In FIGS. 5-8, the pusher 184 is able to extend past both the bottom and top of the housing 182; however, the rest of the feed advance mechanism is exactly the same as the first embodiment (i.e., FIGS. 1-4 and 9-14). Note that the slide body 12 is barely visible in FIG. 5, as most of it is hidden behind the “slide body frame” 13; the slide body 12 literally slides along this slide body frame 13 during a fastener driving stroke—i.e., the slide body appears to ‘retract’ into the slide body frame 13 as the nosepiece is further pushed against a target substrate during the fastener driving stroke. The slide body frame 13 is also referred to herein as the feed tube 13 or the “feed tube portion” 13.

Referring now to FIG. 6, the initial phase of the driving stroke of the “active” driving state has been completed, in which the nosepiece 15 and slide body 12 have been depressed, and the stopper 40 has been moved so that it is now out of contact with the sprocket extension 62. This stopper 40 position depicted in FIG. 6 is sometimes referred to herein as a “second position” of the stopper. The nose of the drive bit 14 (not seen in this view, as it is directly behind the sprocket 60) is now in contact with the head of the ‘next’ screw 28, and thus the screw 28 is ready to be driven into a substrate. Note that in FIGS. 6-9, the gear 30 is not shown to more clearly illustrate the feed pawl S/A 70. FIG. 6 illustrates the position of the slide body 12 at the position where the cam roller 36 has been moved past a sloped portion (also sometimes referred to herein as a “curved portion”) of the cam profile slot 37, and the cam roller 36 is now positioned within a linear portion of the cam profile slot 37. The slide body 12 can be further depressed during a second phase of the driving stroke in which the screw 28 is now driven into a target substrate, as that “lead screw” becomes stripped away from the flexible collated strip 26, and while this occurs the cam roller 36 now moves along the straight portion of the cam profile slot 37.

Once the “lead” screw 28 has been fully driven into the target substrate, the user then will lift the tool 10 away from the substrate beginning a return stroke. The slide body 12 will quickly extend outward from the feed tube 13. This movement forces the cam roller 36 through the straight portion of the cam profile slot 37 towards the curved portion. Once the cam roller 36 reaches the curved portion, the sprocket 60 indexes the collated screw strip 26 to the next screw. As the cam roller 36 moves further down the curved portion of the cam profile slot 37, the finger 76 moves and forces the stopper 40 to move protrusion C so that it will “catch” one of the sprocket extensions 62, thereby preventing overshooting.

Another way of describing this action is as follows: the feed tube 13 is hollow with an opening at a distal end, and is sized and shaped to allow the slide body subassembly 12 to slide therethrough from the distal end toward a proximal end. The cam profile slot 37 is in a side of the feed tube 13, the cam profile having a straight portion and a curved portion. The cam roller 36 moves through the cam profile slot 37 as the slide body subassembly is moved through the feed tube, the cam roller being in mechanical communication with the feed pawl S/A. As the cam roller moves through the curved portion of the cam profile slot, the extending finger of the feed pawl S/A moves and forces the stopper to move between the first and second positions.

Referring now to FIG. 8, the “locked” state (or locked position) is illustrated, in which the nosepiece 15 is extended, the stopper 40 is in contact with the sprocket extension 62, and therefore, the sprocket 60 cannot overshoot (and move the next screw 28 out of position for contact with the drive bit 14 during the next drive stroke). This stopper 40 position depicted in FIG. 8 is sometimes referred to herein as a “first position” of the stopper. This locked state continues into the initial portion or phase of a driving state, so that the sprocket 60 cannot overshoot while the nosepiece 15 begins to be “pushed in.”

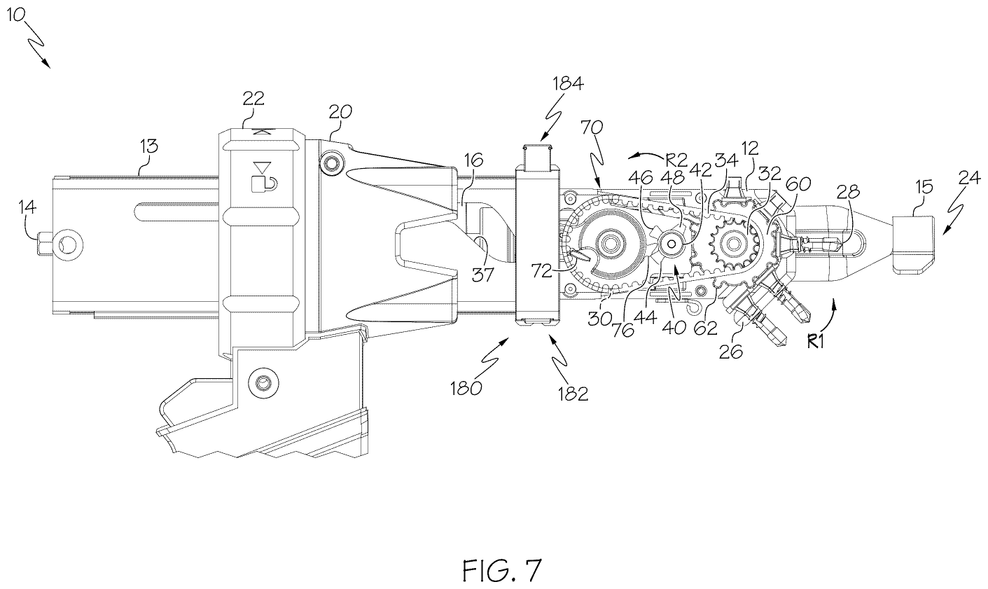

The “locked” state depicted in FIG. 8 is the default state of the attachment 10; i.e., the stopper 40 is maintained at its first position between driving strokes, and also while the screw-driving tool is turned off. This also is how the attachment is shipped. In this locked state, the sprocket 32 cannot be rotated, which means that a collated strip of fasteners cannot be ‘loaded’ into, or ‘unloaded’ from the tool while in that locked state. This situation is overcome by providing a “freewheeling” or “neutral” state, which is now described, in reference to FIG. 7.

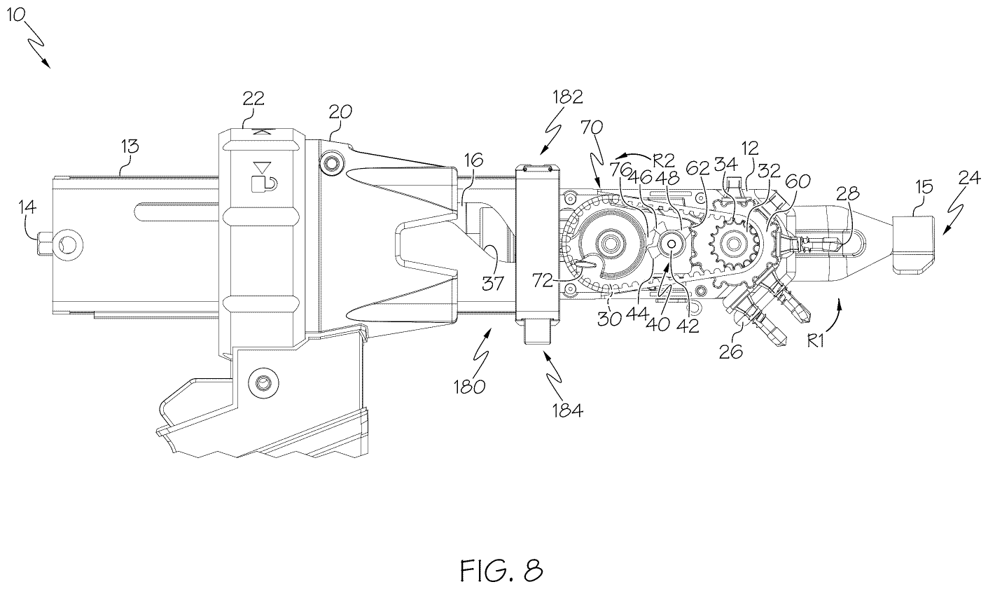

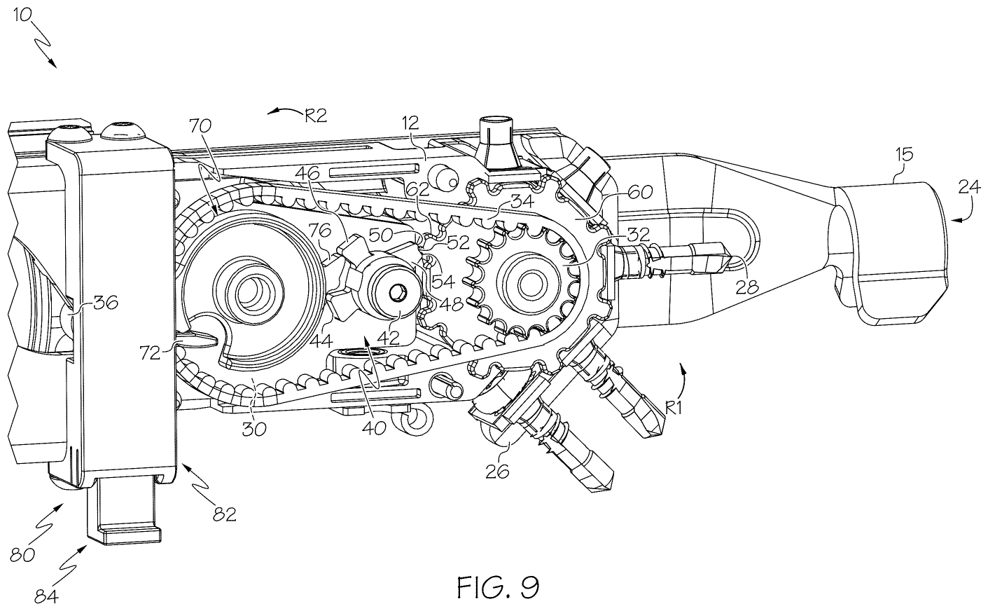

FIG. 7 depicts the attachment 10 in an unload/reload state (i.e., in the “neutral” state). In this alternative embodiment release bar S/A 180, the pusher 184 is depicted as extending past the top of the housing 182, in an “engaged” position. Note that the first embodiment release bar S/A 80 is depicted without an opening at the top of the housing 82 (such as depicted in FIG. 9, for example). Both embodiments function exactly the same, as discussed hereinbelow. The stopper 40 is now in a “neutral” state, and FIG. 7 depicts the stopper in a position that is sometimes referred to herein as being in a “third position” of the stopper.

When the user manually pushes the pusher 184 into the engaged position, the pusher 184 contacts the cam roller 36 and forces the cam roller 36 “upwards” and out of mechanical communication with the feed mechanism. However, the engaged position does not involve depressing the nosepiece 15. In the engaged position, the stopper 40 is out of contact with the sprocket 60, and therefore the feed mechanism can “free wheel” in the direction R1 to allow a user to unload or reload the collated screw strip 26. Note that the one-way clutch 72 prevents the feed mechanism from “free-wheeling” in the rotational direction opposite to R1. When the user is finished loading or unloading the screw strip, the tool 10 can then be used normally, because when the nosepiece is depressed, the pusher 184 is automatically returned to the “disengaged” position, the cam roller 36 moves “downward,” and the feed mechanism can no longer free wheel.

FIG. 9 depicts the locked position, showing the finger 76 in contact with the protrusion B (at 46), and the protrusion C (at 48) in contact with the sprocket extension 62. In the locked position, the sprocket extension 62 is unable to rotate due to being in contact with the notch 52 of the protrusion C (at 48).

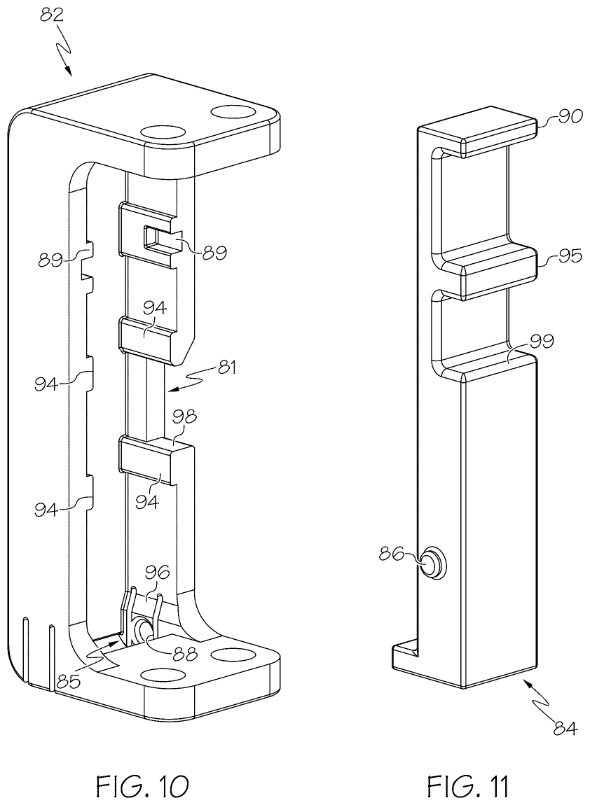

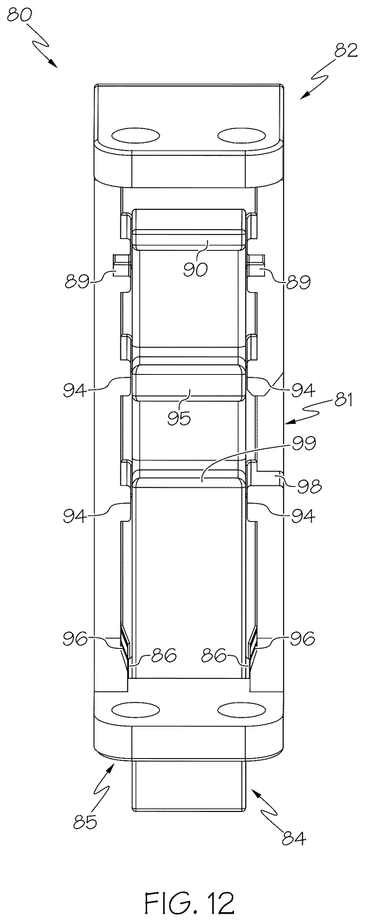

FIGS. 10-14 depict the first embodiment movable release bar S/A 80, and a retainer pin 87 is not shown in these drawings for purposes of clarity. Referring now to FIG. 10, the housing 82 is depicted showing a plurality of guide surfaces 94 on the interior, an interior shelf 98, flex portions 96 (one on each side of the housing 82), a plurality of detents 88 (one on each side of the housing 82), and an opening 85. The pusher 84 fits through the opening 85 (see FIG. 12).

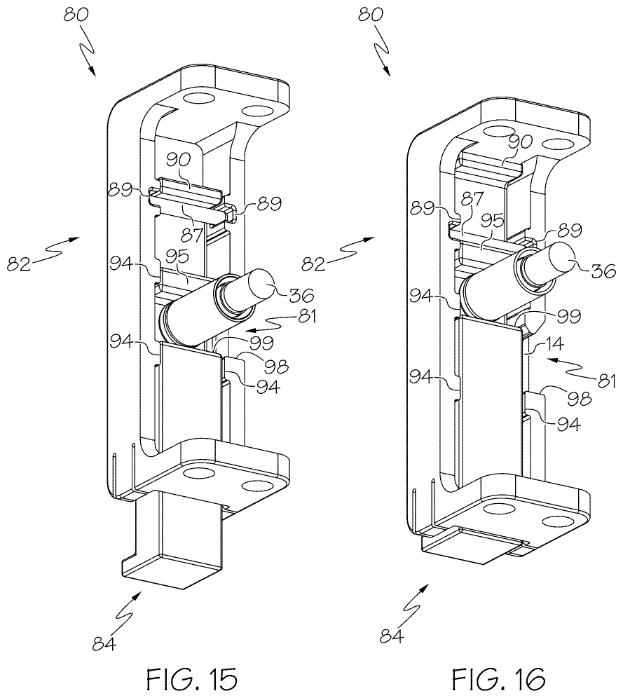

Notches 89 are provided in the housing 82, and the retainer pin 87 is positioned within these notches 89 (see FIGS. 15-16). The housing 82 exhibits a gap 81, which allows the cam roller 36 to function normally during operation; i.e., the cam roller 36 slides out through the gap 81 at the beginning of a drive stroke, and later slides back in through the gap 81 at the end of a return stroke.

Referring now to FIG. 11, the pusher 84 is depicted showing a first flange 90, a second flange 95, the contact portion 99, and a plurality of dimples 86 (one on each side of the pusher 84). When the movable release bar S/A 80 is assembled, the pusher 84 is pushed through the opening 85 until the dimples 86 seat into the detents 88. This assembled state is depicted on FIG. 12. During operation, the cam roller 36 slides over the contact portion 99 as the cam roller 36 moves out and back in through the gap 81 in the housing 82.

In FIG. 12, the cam roller 36 (not shown in this view) slides along the contact portion 99 during operation (as noted above). When the pusher 84 is pushed “up,” the flex portions 96 “flex” to allow the dimples 86 to move out of the detents 88.

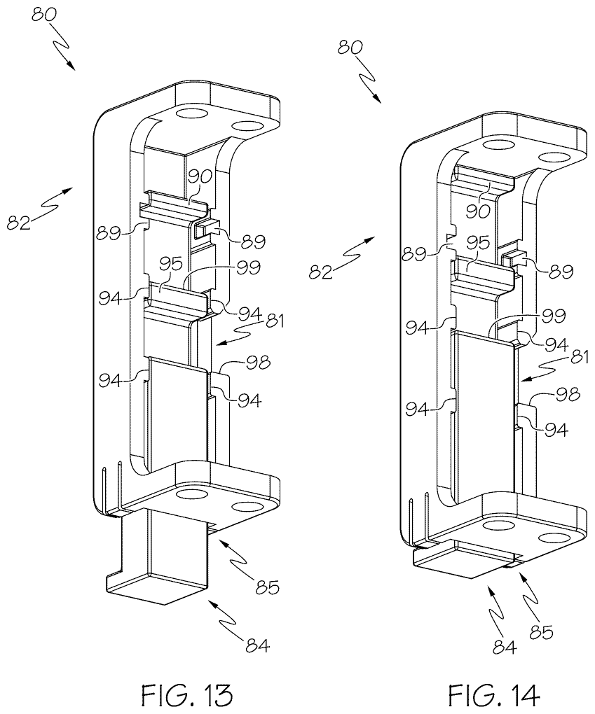

FIG. 13 depicts the disengaged position of the pusher 84, whereas FIG. 14 depicts the engaged position of the pusher 84. In FIG. 13, the pusher 84 is at its lowest position, in which the dimples 86 are seated in the detents 88. The cam roller 36 (not shown in this view) is free to slide in and out through the gap 81.

FIG. 14 illustrates the engaged position, in which the pusher 84 is at its highest position. The dimples 86 have moved out of contact with the detents 88, and the contact portion 99 has moved the cam roller 36 (not shown in this view) “upwards” and out of mechanical communication with the nosepiece 15 and the slide body 12. In the engaged position, a user can manually unload, or reload, the collated strip of screws 26, and when finished, the user then presses down on the nosepiece 15 to begin a new drive stroke. As the nosepiece 15 is depressed, the cam roller 36 automatically forces the pusher 84 back into the disengaged position, thereby allowing the user to operate the tool 10. Alternatively, the user could manually move the pusher 84 back to the disengaged position.

Referring now to FIG. 15, the pusher 84 is in the disengaged position, in which the cam roller 36 can slide in and out of the gap 81. The retainer pin 87 is depicted mounted in the notches 87 of the housing 82. The first flange 90 contacts the retainer pin 87 with the pusher 84 in the disengaged position, and the retainer pin 87 prevents the pusher 84 from potentially falling out of the housing 82.

Referring now to FIG. 16, the pusher 84 has been moved to the engaged position, in which the cam roller 36 has moved “upwards” (in this view) and in-between the guides 94. FIG. 16 depicts a temporary position of the pusher 84 and the cam roller 36 that allows a user to load or unload the collated strip of fasteners 26.

It will be understood that the attachment 10 that is illustrated in FIGS. 1-16 can be used both with single-feed screwdrivers and with autofeed screwdriver “back-end” tool portions. When used with a single-feed screwdriver, many autofeed attachments have adapters that allow a first brand of a “front-end” tool portion to be attached to a second brand of a “back-end tool,” thereby creating a complete autofeed screwdriving tool from a single-feed screwdriver. Or, when used with an autofeed “back-end” tool portion, the attachment as disclosed in FIGS. 1-16 completes that autofeed screwdriving tool, and typically both ‘halves’ of that complete tool are supplied by the same tool manufacturer, and can be referred to as an “integrated tool.” The use of an attachable/detachable front-end tool portion makes that integrated tool somewhat more flexible, since if one-half of that integrated tool should have an operating problem, the other half usually can be operated successfully with a replacement part for the ‘problem’ half.

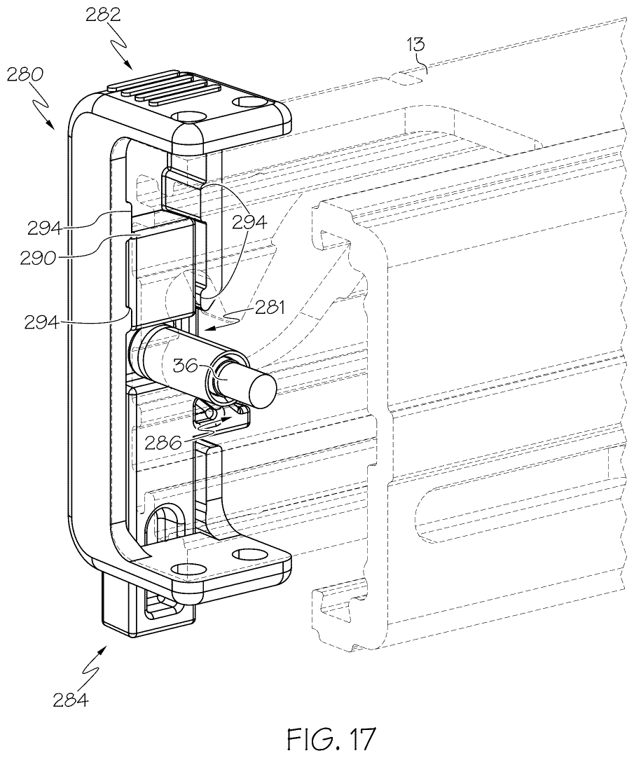

Referring now to FIG. 17, a second alternative embodiment release bar subassembly (“S/A”) 280 is illustrated, including a housing 282, a pusher 284 having a top end 290, and an opening 281. The interior of the housing 282 includes a plurality of guide surfaces 294 that constrain the pusher 284 so that the pusher only slides “up” and “down” (in this view) and not “side to side.” FIG. 17 depicts the second alternative embodiment release bar subassembly 280 in a disengaged position, in which the cam roller 36 has moved into the opening 281. In the disengaged position, the cam roller 36 is free to move in and out of the opening 281 during operation of the attachment 10.

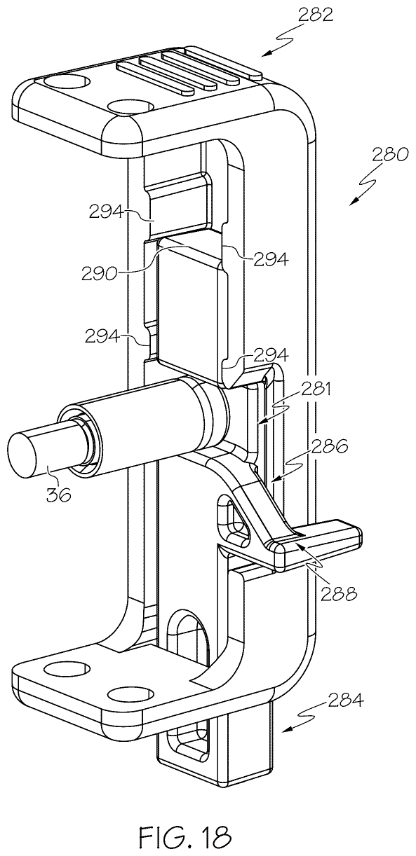

Referring now to FIG. 18, the disengaged position is depicted again, with the cam roller 36 seated in the opening 281. As with the other release bar subassembly embodiments discussed above, this second alternative embodiment 282 exhibits an engaged position when the pusher 284 is pressed “upwards” (in this view). The top end 290 will move upwards, along with the opening 281, which simultaneously moves the cam roller 36 into a temporary position that allows a user to load or unload the collated strip of fasteners 26.

The second alternative release bar subassembly 280 includes a ramp 286 proximal to the opening 281. A jam condition may occur if the release bar subassembly 280 has moved from the disengaged position to the engaged position, without the cam roller 36 being seated in the opening 281. However, with the addition of the ramp 286, during operation of the attachment 10 the cam roller 36 itself will move the pusher 284 from the engaged position back to a disengaged position, and then seat into the opening 281.

For example, a user has already depressed the slide body 12 into the feed tube 13, which also moves the cam roller 36 into the feed tube. At this point, one screw has been driven into a workpiece, and somehow the release bar S/A 280 is moved into the engaged position, wherein the pusher 284 is pushed “up” (in this view). The ramp 286 also moves to fill the upper portion of the opening 281. Next, as the user releases from the workpiece, the slide body 12 begins to automatically extend out from the feed tube 13, and the cam roller 36 begins to move in the same direction as the slide body. The cam roller 36 will move into contact with a contact portion 288, which guides the cam roller 36 to slide onto the ramp 286. As the cam roller 36 slides along the ramp 286, the pusher 284 is forced back into the disengaged position, and the cam roller 36 safely moves into the opening 281, as depicted in FIG. 18. At this point, the slide body 12 has fully extended out from the feed tube 13, ready for another drive cycle.

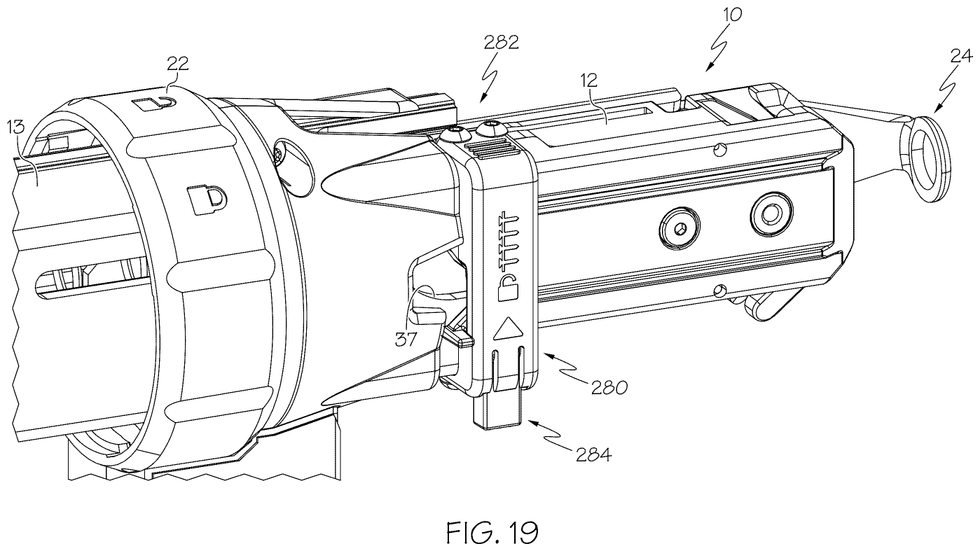

Referring now to FIG. 19, the second alternative embodiment release bar subassembly 280 is depicted along with the attachment 10. Again, similar to the other release bar embodiments, a user presses the pusher 284 to load or unload the collated strip of fasteners 26.

Note that some of the embodiments illustrated herein do not have all of their components included on some of the figures herein, for purposes of clarity. To see examples of such outer housings and other components, especially for earlier designs, the reader is directed to other U.S. patents and applications owned by Senco. Similarly, information about “how” the electronic controller operates to control the functions of the tool is found in other U.S. patents and applications owned by Senco. Moreover, other aspects of the present tool technology may have been present in earlier fastener driving tools sold by the Assignee, Kyocera Senco Industrial Tools, Inc., including information disclosed in previous U.S. patents and published applications. Examples of such publications are listed above. These documents are incorporated by reference herein, in their entirety.

It will be further understood that any type of product described herein that has moving parts, or that performs functions (such as computers with processing circuits and memory circuits), should be considered a “machine,” and not merely as some inanimate apparatus. Such “machine” devices should automatically include power tools, printers, electronic locks, and the like, as those example devices each have certain moving parts. Moreover, a computerized device that performs useful functions should also be considered a machine, and such terminology is often used to describe many such devices; for example, a solid-state telephone answering machine may have no moving parts, yet it is commonly called a “machine” because it performs well-known useful functions.

As used herein, the term “proximal” can have a meaning of closely positioning one physical object with a second physical object, such that the two objects are perhaps adjacent to one another, although it is not necessarily required that there be no third object positioned therebetween. In the technology disclosed herein, there may be instances in which a “male locating structure” is to be positioned “proximal” to a “female locating structure.” In general, this could mean that the two male and female structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two male and female structures actually touch one another along a continuous surface. Or, two structures of any size and shape (whether male, female, or otherwise in shape) may be located somewhat near one another, regardless if they physically abut one another or not; such a relationship could still be termed “proximal.” Or, two or more possible locations for a particular point can be specified in relation to a precise attribute of a physical object, such as being “near” or “at” the end of a stick; all of those possible near/at locations could be deemed “proximal” to the end of that stick. Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

What is claimed is:

1. A slide body subassembly for an automatic fastener driving tool, said slide body subassembly comprising:
(a) a drive gear having a first axis of rotation, said drive gear having a first set of engagement projections along one of its surfaces at a first position along said first axis of rotation;
(b) a sprocket having a second axis of rotation that is substantially parallel to said first axis of rotation, and that is spaced-apart from said drive gear, said sprocket having a first plurality of spaced-apart protrusions along an outer curved surface at a third position along said second axis of rotation, said sprocket having a second set of engagement projections at a fourth position along said second axis of rotation;
(c) a drive belt that runs between said drive gear and said sprocket, said drive belt having a plurality of spaced-apart bulges along one of its surfaces, said plurality of spaced-apart bulges being in mechanical engagement with said first set of engagement projections of said drive gear and being in mechanical engagement with said second set of engagement projections of said sprocket, said drive belt being caused to move if said drive gear rotates, and said drive belt then causing said sprocket to rotate;
(d) a flexible collated strip of fasteners that slides over a surface of said slide body subassembly, said flexible strip having a plurality of spaced-apart openings that engage with said first plurality of spaced-apart protrusions of the sprocket, and are thereby indexed into a drive position by rotation action of said sprocket about said second axis of rotation;
(e) a feed pawl subassembly that is associated with the drive gear, said feed pawl subassembly including an extending finger; and
(f) a stopper that includes a plurality of protrusions, said stopper being positioned in a space between said drive gear and said sprocket, wherein:
(i) if the stopper is moved to a first position, a final one of the stopper's plurality of protrusions makes contact with the sprocket and prevents the sprocket from overshooting;
(ii) if the stopper is moved to a second position, none of the stopper's plurality of protrusions makes contact with the sprocket, and said sprocket is free to rotate and thereby allow said flexible collated strip of fasteners to be indexed as needed to place a fastener at an appropriate drive position;
(iii) if in operation, during a drive stroke, the sprocket remains in place at least until a drive bit contacts a “lead” fastener to be driven;
(iv) if in operation, before a first phase of a return stroke, the extending finger of said feed pawl subassembly makes physical contact with a first one of the plurality of protrusions of the stopper, which causes the stopper to move toward the second position, thereby allowing the sprocket to rotate;
(v) if in operation, during a second phase of the return stroke, the sprocket is indexed to place a “next” fastener at a “lead” position, where it is ready to be driven by the drive bit; and
(iv) if in operation, during a third phase of the return stroke, the extending finger of said feed pawl subassembly makes physical contact with a second one of the plurality of protrusions of the stopper, which causes the stopper to move to the first position, which thereby prevents the sprocket from overshooting.

2. The slide body subassembly of claim 1, further comprising:
a nosepiece that is movable between an extended position and a retracted position, and is in mechanical communication with the drive gear;
wherein:
when the nosepiece is in the extended position, the stopper is in the first position;
when the nosepiece is in the retracted position, the stopper is in the second position; and
when the nosepiece automatically returns from the retracted position to the extended position, the drive gear is rotated, which forces the drive belt to move, which then forces the sprocket to rotate, thereby advancing the flexible collated strip of fasteners.

3. The slide body subassembly of claim 2, further comprising:
a release bar subassembly that is movable between a disengaged and an engaged position;
wherein:
when the release bar subassembly is in the disengaged position, the stopper can only move between the second position and the first position; and
when the release bar subassembly is in the engaged position, the stopper can only move to a third position, wherein none of the stopper's plurality of protrusions makes contact with the sprocket, and the nosepiece is not in mechanical communication with the drive gear.

4. The slide body subassembly of claim 3, wherein:
in the third position, the drive gear, the drive belt, and the sprocket can freewheel in one direction to either load or unload the flexible collated strip of fasteners; and
when the nosepiece is moved to the retracted position, the release bar subassembly is automatically moved to the disengaged position.

5. The slide body subassembly of claim 1, wherein:
the final protrusion of the stopper exhibits a curved portion, a notch portion, and a flat portion; wherein:
when the stopper is moved to the first position, an extension of the sprocket contacts and slides along the flat portion first, and then seats into the notch portion, thereby preventing the sprocket from overshooting.

6. The slide body subassembly of claim 1, wherein:
the drive bit is rotatable;
the fasteners are screws;
the rotatable drive bit is allowed to contact the “lead” one of the flexible collated strip of screws when the stopper is moved to the second position; and
during the drive stroke, the slide body subassembly is retracted into a feed tube, so that the rotatable drive bit forces the “lead” screw to tear loose from the flexible strip of collated screw as the “lead” screw is driven into a substrate.

7. The slide body subassembly of claim 1, further comprising:
a feed tube that is hollow with an opening at a distal end, and is sized and shaped to allow the slide body subassembly to slide therethrough from the distal end toward a proximal end;
a cam profile slot in a side of the feed tube, said cam profile having a straight portion and a curved portion; and
a cam roller that moves through the cam profile slot as the slide body subassembly is moved through the feed tube, the cam roller being in mechanical communication with the feed pawl subassembly;
wherein, as the cam roller moves through the curved portion of the cam profile slot, the extending finger of the feed pawl subassembly moves and forces the stopper to move between the first and second positions.

8. An autofeed screwdriver attachment, comprising:
a movable slide body including an independently movable nosepiece;
a rotatable drive bit;
a drive gear, a sprocket, and a drive belt that runs between the drive gear and the sprocket;
a stopper exhibiting a plurality of protrusions, the stopper located between the drive gear and the sprocket; and
a flexible collated strip of screws that engage with the sprocket;
wherein:
the nosepiece is movable between an extended position, and a retracted position, the nosepiece being in mechanical communication with the drive gear;
at an initial portion of a driving stroke, the nosepiece resides in the extended position, and the rotatable drive bit is not yet contacting one of the screws of the flexible collated strip of screws;
at the end of said driving stroke, the nosepiece resides in the retracted position, and none of the plurality of protrusions makes contact with the sprocket; and
during a return stoke, the nosepiece automatically returns to the extended position from the retracted position, and a final one of the plurality of protrusions is moved into contact with the sprocket.

9. The attachment of claim 8, wherein:
when the final one of the plurality of protrusions makes contact with the sprocket, the stopper is in a first position; and
when none of the plurality of protrusions makes contact with the sprocket, the stopper is in a second position.

10. The attachment of claim 9, further comprising:
a feed pawl subassembly including an extending finger, the feed pawl subassembly being in mechanical communication with the drive gear;
wherein:
in the first position, the extending finger is moved into contact with a second one of the plurality of protrusions; and
in the second position, the extending finger is moved into contact with a third one of the plurality of protrusions.

11. The attachment of claim 10, further comprising:
a release bar subassembly that is movable between a disengaged and an engaged position;
wherein:
when the release bar subassembly is in the disengaged position, the stopper can only move between the second position and the first position; and
when the release bar subassembly is in the engaged position, the stopper can only move to the second position, and the nosepiece is not in mechanical communication with the drive gear.

12. The attachment of claim 11, further comprising:
a one-way clutch in mechanical communication with the drive gear, the one-way clutch prevents back rotation of the drive gear;
wherein:
in the engaged position, the drive gear, the drive belt, and the sprocket can freewheel in one direction to either load or unload the flexible strip of screws; and
when the nosepiece is moved to the retracted position, the release bar subassembly is automatically moved to the disengaged position.

13. The slide body subassembly of claim 8, wherein:
the first one of the plurality of protrusions exhibits a curved portion, a notch portion, and a flat portion; and
when the stopper is moved to the first position, an extension of the sprocket contacts and slides along the flat portion first, and then seats into the notch portion, thereby preventing the sprocket from overshooting.

14. A method for advancing a fastener for an attachment to a power tool, the method comprising:
(a) providing a power tool attachment including:
a movable slide body including a movable nosepiece;
a rotatable drive bit;
a drive gear, a sprocket, and a drive belt that runs between the drive gear and the sprocket, the drive gear being in mechanical communication with the movable nosepiece; and
a stopper exhibiting a plurality of protrusions, the stopper located between the drive gear and the sprocket;
(b) providing a flexible collated strip of fasteners that engage with the sprocket;
(c) before beginning a driving stroke, the stopper is in a first position, in which a final one of the plurality of protrusions of the stopper is in contact with the sprocket, thereby preventing overshooting of the sprocket;
(d) beginning an operating cycle with a driving stroke by depressing the movable nosepiece against a substrate, causing the movable nosepiece to move toward a retracted position;
wherein:
the rotatable drive bit contacts one of the fasteners of the flexible strip of fasteners; and
the stopper moves to a second position, causing the final one of the plurality of protrusions to move out of contact with the sprocket, thereby allowing the sprocket to rotate; and
(e) completing the operating cycle with a return stroke by removing the movable nosepiece from the substrate;
wherein:
the movable nosepiece automatically moves to an extended position;
the rotatable drive bit moves out of contact with one of the fasteners of the flexible strip of fasteners; and
the stopper moves back to the first position, and the final one of the plurality of protrusions moves into contact with the sprocket, thereby preventing overshooting.

15. The method of claim 14, further comprising:
providing a feed pawl subassembly that is associated with the drive gear, said feed pawl subassembly including an extending finger; and
during the driving stroke, the extending finger of said feed pawl subassembly makes physical contact with a first one of the plurality of protrusions of the stopper, which causes the stopper to release from the first position and thereby releases from making contact with the sprocket.

16. The method of claim 14, further comprising:
during a final phase of the return stroke, moving the extending finger of said feed pawl subassembly so that the extending finger:
(a) releases from making physical contact with the first one of the plurality of protrusions of the stopper; and
(b) then makes physical contact with a second one of the plurality of protrusions of the stopper, which causes the stopper to move to the first position, and the final one of the plurality of protrusions of the stopper again makes contact with the sprocket, thereby preventing overshooting.

17. The method of claim 16, further comprising:
providing a slide body that includes the drive gear, the sprocket, and the drive belt;
during the driving stroke, retracting the slide body into a feed tube portion of the attachment, so that the rotatable drive bit forces the fastener to tear loose from the flexible strip of collated fasteners as the fastener is driven into the substrate.

18. A method for loading a flexible strip of fasteners for an attachment to a power tool, the method comprising:
(a) providing a power tool attachment including:
a movable slide body including a movable nosepiece;
a rotatable drive bit;
a drive gear, a sprocket, and a drive belt that runs between the drive gear and the sprocket, the drive gear being in mechanical communication with the movable nosepiece;
a stopper exhibiting a plurality of protrusions, the stopper being located between the drive gear and the sprocket; and
a release bar subassembly that is movable between a disengaged position and an engaged position;
(b) providing a flexible strip of collated fasteners that are engageable with the sprocket;
(c) the release bar subassembly is at a disengaged position as a default mode of operation, wherein:
the nosepiece is in mechanical communication with the drive gear;
the stopper moves to a first position in which a final one of the plurality of protrusions is in contact with the sprocket; and
the stopper prevents the sprocket from indexing in at least one direction;
(d) moving the release bar subassembly to the engaged position, wherein:
the nosepiece is not in mechanical communication with the drive gear;
the stopper moves to a second position and is not in contact with the sprocket; and
the sprocket can freewheel in at least one direction; and
(e) loading the flexible strip of fasteners onto the sprocket.

19. The method of claim 18, further comprising:
(a) beginning a driving stroke by depressing the movable nosepiece against a substrate, causing the movable nosepiece to move toward a retracted position, wherein:
the release bar subassembly automatically moves to the disengaged position;
the nosepiece is in mechanical communication with the drive gear;
the stopper moves to a third position in which the final one of the plurality of protrusions is not in contact with the sprocket; and
the sprocket is not prevented from rotating;
(b) continuing the driving stroke, so that the rotatable drive bit contacts a fastener of the flexible strip of fasteners, wherein:
the rotatable drive bit forces the fastener to tear loose from the flexible strip of collated fasteners as the fastener is driven into a substrate;
the stopper remains in the third position, causing the final one of the plurality of protrusions to remain out of contact with the sprocket, thereby allowing the sprocket to rotate; and
(c) removing the movable nosepiece from the substrate, wherein:
the movable nosepiece automatically moves to an extended position;
the rotatable drive bit moves out of contact with said one of the fasteners of the flexible strip of fasteners; and
the stopper moves back to the first position, and the final one of the plurality of protrusions moves into contact with the sprocket, thereby preventing overshooting.

20. The method of claim 19, further comprising:
providing a slide body that includes the drive gear, the sprocket, and the drive belt;
during the driving stroke, retracting the slide body into a feed tube portion of the attachment, so that the rotatable drive bit forces the fastener to tear loose from the flexible strip of collated fasteners as the fastener is driven into the substrate.
